(19) United States
(12) Patent Application Publication
(10) Pub. No.: US 2026/0025752 A1
(43) Pub. Date: Jan. 22, 2026

(54) AP-UE ASSOCIATION ALGORITHM FOR MASSIVE ACCESS SCENARIO IN USER-CENTRIC CELL-FREE MASSIVE MIMO SYSTEM WITH LOW-RESOLUTION ADC

(71) Applicant: INDUSTRY ACADEMY COOPERATION FOUNDATION OF SEJONG UNIVERSITY, Seoul (KR)

(72) Inventors: Hyoung Kyu SONG, Seongnam-si (KR); Young Hwan YOU, Seoul (KR); Jin Woo KIM, Dongducheon-si (KR); Keyung Ho SHIN, Seoul (KR); Yoon Ju CHOI, Incheon (KR)

(73) Assignee: INDUSTRY ACADEMY COOPERATION FOUNDATION OF SEJONG UNIVERSITY, Seoul (KR)

(21) Appl. No.: 18/907,325

(22) Filed: Oct. 4, 2024

(30) Foreign Application Priority Data
Jul. 18, 2024 (KR) 10-2024-0094785

(51) Int. Cl. H04W 48/20; H04B 7/0452; H04W 28/02; H04W 48/06

(52) U.S. Cl. CPC H04W 48/20; H04B 7/0452; H04W 28/0236; H04W 48/06

(57) ABSTRACT

The present disclosure relates to a method for association between an AP and user equipment (UE) for a massive access scenario using a low-resolution analog to digital converter (ADC) in a user-centric cell-free massive MIMO system, and K UEs select a master AP among L APs based on a large-scale fading coefficient (LSFC), and the AP selects a UE to associate based on the information. The present disclosure relates to a method of causing unassociated UEs to attempt to associate until all UEs are associated with an AP through a repeating process and a system using the same.

### CROSS-REFERENCE TO RELATED APPLICATION

This application claims priority to Korean Patent Application No. 10-2024-0094785 filed on Jul. 18, 2024 and all the benefits accruing therefrom under 35 U.S.C. § 119, the contents of which are incorporated by reference in their entirety.

### BACKGROUND

The present disclosure relates to an access Point (AP)-user equipment (UE) association algorithm that guarantees association for all UEs within a network and eliminates overserving APs by selecting a master AP for massive access in a user-centric cell-free massive multiple-input multiple-output (MIMO) system using a low-resolution analog to digital converter (ADC).

Massive multiple-input multiple-output (MIMO) systems are a key technology for 5G wireless communication systems as a technology for supporting many users simultaneously with the same resources using a large number of antennas in an access point (AP) or base station (BS).

The channel hardening characteristics and favorable propagation characteristics of massive MIMO systems may increase spectral efficiency (SE) and energy efficiency (EE), and show performance close to optimal performance with simple linear signal processing techniques in the AP.

A lot of research is being conducted on cellular structures based on the massive MIMO systems, but users located at an edge of a cell are far from the base station and are subject to interference from other cells in the vicinity, which causes performance degradation, and thus there is a problem that the performance difference with users located at the center of the cell is large.

In order to solve the aforementioned problem, cell-free massive MIMO systems are being studied as a key technology for Beyond 5G (B5G) and 6G in that the systems are capable of guaranteeing better performance and improving the edge effect of the existing cellular networks since multiple APs within a coverage area cooperate to support users, unlike the existing cellular systems.

In the cell-free massive MIMO system in the related art, multiple APs and user equipment (UE) are distributed within a service area, and all UEs communicate using the same time-frequency resources as the APs. All APs are associated with the CPU via a fronthaul link to share information, and the CPU encodes or decodes data received from the APs. In this way, the cell-free massive MIMO system has the advantage of higher spectral efficiency, energy efficiency, and coverage probability than existing cellular systems.

However, the cell-free massive MIMO system in the related art, in which all APs simultaneously support all UEs, experiences rapidly increasing fronthaul capacity requirements and computational complexity as the number of APs and UEs within the network increases. Another architecture of the cell-free massive MIMO is a user-centric Cell-Free Massive MIMO system, in which subsets of APs form a cluster to support UEs, and this approach may reduce the load on the fronthaul link and achieve scalability compared to the cell-free massive MIMO system in the related art.

Therefore, an important challenge in the user-centric cell-free massive MIMO system proposed in the present disclosure is to select and associate subsets of APs supporting UEs, which is referred to as a cluster, and this is referred to as an association between the AP and the UE. Even in a massive access environment with a very large number of UEs, the user-centric cell-free MIMO system has the advantage of guaranteeing better performance than cellular systems in the related art. In addition, the user-centric cell-free MIMO system is more suitable than the cell-free massive MIMO system in the related art in the massive access environment because the user-centric cell-free MIMO system is capable of reducing the load on the fronthaul link.

However, since there are many UEs, there may be UEs that are not supported by the AP. In addition, in the user-centric cell-free MIMO system, channel estimation is performed using orthogonal pilots between UEs in an uplink phase, but in the massive access environment, pilot contamination may occur due to a lack of orthogonal pilots. This is a major factor in the degradation of spectral efficiency performance in the user-centric cell-free MIMO system.

Examples of the related art include Korean Patent Publication No. 10-2023-0088591 (Jun. 20, 2023) and Korean Patent Publication No. 10-2022-0061907 (May 13, 2022).

### SUMMARY

A user-centric cell-free MIMO system in which a large number of APs using one or more antennas synchronously support user equipment is capable of guaranteeing high spectral efficiency and consistent quality of service to the user equipment. However, since there are many APs in a cell-free massive MIMO system, the number of radio frequency (RF) chains also increases accordingly, and using a high-resolution analog to digital converter (ADC) in a RF chain is impractical due to high power consumption and large hardware cost. In addition, since as the number of users increases, the required fronthaul link capacity increases, the increase needs to be reduced in the massive access environment.

In addition, in the massive access environment, since the number of UEs is large, there may be UEs that are not supported by the APs, and the APs have to support an equal or smaller number of UEs than that of orthogonal pilots to prevent pilot interference.

In order to solve the aforementioned technical problem, in accordance with an exemplary embodiment, there is provided a method for association between an AP and a user equipment (UE) for a massive access scenario using a low-resolution analog to digital converter (ADC) in a user-centric cell-free massive MIMO system, including selecting, by each of two or more UEs, an AP as a master AP among two or more APs according to a large-scale fading coefficient (LSFC) to request an association, selecting, by the master AP that has received the association request from the two or more UEs, a UE to be associated according to the large-scale fading coefficient to perform the association, and repeating the association by re-performing, by UEs that are not associated through the selecting of the AP and the selecting of the UE, the selecting of the AP and the selecting of the UE.

In the selecting of the AP, each of the UEs may calculate large-scale fading coefficient values with the APs, and each of the UEs may select the AP having a largest large-scale fading coefficient value with the UE itself as the master AP and request the association.

In the selecting of the UE, a first master AP that has received the association request from each of the UEs among the APs may compare the large-scale fading coefficients with each of the UEs, a first UE having a maximum value among the large-scale fading coefficient values of the UEs requesting the association may be selected and associated, and the first master AP may exclude association requests from UEs having lower large-scale fading coefficients than the first UE as a result of the comparison.

The first master AP may prevent re-association by including the excluded UEs in an exclusion list of the first master AP.

In the repeating of the association, the UEs included in the exclusion list may perform the selecting of the AP again, and a second master AP that has received the association request in the selecting of the AP performed again may perform the selecting of the UE again.

In the repeating of the association, the selecting of the AP and the selecting of the UE may be repeated until all of the UEs are associated with at least one AP.

In accordance with another exemplary embodiment, there is provided a system for association between an AP and a UE for a massive access scenario using a low-resolution analog to digital converter (ADC) in a user-centric cell-free massive MIMO system, including an AP selector configured to perform a process in which each of two or more UEs selects a master AP among two or more APs according to a large-scale fading coefficient to request an association, a UE selector configured to perform a process in which the master AP that has received association requests from the two or more UEs selects a UE to be associated according to the large-scale fading coefficient to perform the association, and an association repeat instructor configured to instruct UEs that are not associated through the processes of the AP selector and the UE selector to re-perform the processes of the AP selector and the UE selector.

The AP selector may be configured such that each of the UEs calculates large-scale fading coefficient values with the APs, and each of the UEs selects the AP having a largest large-scale fading coefficient value with the UE itself as the master AP and makes the association request.

The UE selector may be configured such that a first master AP that has received the association request from each of the UEs among the APs compares the large-scale fading coefficients with each of the UEs, a first UE having a maximum value among the large-scale fading coefficient values of the UEs requesting the association is selected and associated, and the first master AP excludes association requests from UEs having lower large-scale fading coefficients than the first UE as a result of the comparison.

The first master AP may prevent re-association by including the UEs whose association requests are excluded in an exclusion list of the first master AP.

The association repeat instructor may be configured to instruct the UEs included in the exclusion list to perform the process of the AP selector again and a second master AP that has received the association request from the AP selector that has performed the process again to perform the process of the UE selector again.

The association repeat instructor may be configured to repeatedly perform the processes of the AP selector and the UE selector until all of the UEs are associated with at least one AP.

// [symbol] [symbol] [symbol] //

### BRIEF DESCRIPTION OF THE DRAWINGS

The following drawings attached to the specification illustrate preferred embodiments of the present disclosure by example, and serve to enable technical aspects of the present disclosure to be further understood together with detailed description of the disclosure given above, and therefore the present disclosure should not be interpreted only with matters in such drawings:

FIG. 1 is a flowchart showing a method for association between an

AP and a user equipment (UE) for a massive access scenario using a low-resolution analog to digital converter (ADC) in a user-centric cell-free massive MIMO system of the present disclosure;

FIG. 2 is a flowchart showing a system for association between an AP and a UE for a massive access scenario using a low-resolution ADC in a user-centric cell-free massive MIMO system of the present disclosure;

FIG. 3 is a diagram illustrating a pseudocode of an association algorithm between an AP and a UE of the present disclosure;

FIG. 4 is a graph showing simulation results comparing spectral efficiency (SE) performance of the present disclosure and other algorithms using a maximum ratio (MR) combiner when K=100 (K users with one antenna);

FIG. 5 is a graph showing simulation results comparing SE performance of the present disclosure and other algorithms using the MR combiner when K=160;

FIG. 6 is a graph showing simulation results comparing SE performance of the present disclosure and other algorithms using a local partial-minimum mean square error (LP-MMSE) combiner when K=100; and

FIG. 7 is a graph showing simulation results comparing SE performance of the present disclosure and other algorithms using the LP-MMSE combiner when K=160.

### DETAILED DESCRIPTION OF EMBODIMENTS

// [symbol] [symbol] [symbol] //

Hereinafter, embodiments of the present disclosure will be described

in detail with reference to the accompanying drawings. However, the present disclosure is not limited to the embodiments disclosed below, but will be implemented in a variety of different forms. The embodiments of the present disclosure are only provided to allow the present disclosure to be complete, and to completely inform those skilled in the art of the scope of the present disclosure. Although the terms including ordinal numbers such as first, second, or

the like, may be used to describe various elements, these elements are not limited by these terms. These terms are only used to distinguish one element from another element. For example, without departing from the scope of the present disclosure, a first element could be termed a second element, and similarly, a second element could be termed a first element. The terms used in the present application are merely provided to describe specific embodiments, and are not intended to limit the present disclosure. The singular forms, “a”, “an”, and “the” are intended to include the plural forms as well, unless the context clearly indicates otherwise.

In addition, in the notation of expressions described in equations described below related to the present disclosure, if the meaning of each symbol of the equations is not described, the symbol has the same technical meaning as the meaning of a symbol described in an equation described earlier.

### 1. Method for Association Between AP and UE

The present disclosure provides a method for association between an AP and a user equipment (UE) for a massive access scenario using a low-resolution analog to digital converter (ADC) in a user-centric cell-free massive MIMO system, including selecting, by each of two or more UEs, an AP as a master AP among two or more APs according to a large-scale fading coefficient (hereinafter may be referred to as LSFC) to request an association (S100), selecting, by the master AP that has received the association request from the two or more UEs, a UE to be associated according to the large-scale fading coefficient to perform the association (S200), and repeating the association by re-performing, by UEs that are not associated through the selecting of the AP (S100) and the selecting of the UE (S200), the selecting of the AP (S100) and the selecting of the UE (S200) until all of the UEs are associated with at least one AP.

More specifically, the present disclosure may provide an uplink user-centric cell-free massive MIMO system including L APs having N antennas associated with one CPU (not shown) and K users having single antennas.

To this end, in order to assume a realistic scenario in the present disclosure, each AP has a low-resolution analog to digital converter (ADC), and a quantization noise model due to the low-resolution ADC may use an additive quantization noise model (AQNM).

Assuming a massive access scenario with a very large number of UEs, APs may support only a smaller number of UEs than a pilot length to avoid pilot interference.

Here, the pilot length means the maximum number of UEs that the AP is capable of simultaneously supporting, and represents the limit of network resources. That is, the pilot length may limit the number of UEs that a particular AP is capable of simultaneously handling.

In addition, the present disclosure assumes that each AP knows the distance to all other APs and assumes that the CPU knows the distance between the AP and the UE and a large-scale fading coefficient (hereinafter may be referred to as an LSFC).

In the present disclosure, the large-scale fading coefficient is used for association between a UE and an AP, and incomplete channel state information (CSI) may be considered.

In other words, the association between the AP and the UE may be optimized by taking into account the incomplete CSI. To this end, the association between the AP and the UE may be established using the large-scale fading coefficient, and a heuristic-based association method using empirical rules may be applied taking into account imperfections such as channel estimation errors.

This enables quick decision-making and enables simplification of complex calculations. In addition, in order to minimize association errors caused by incomplete CSI, an exclusion list described below may be utilized to prevent unnecessary re-association attempts, and the AP may select a UE based on the large-scale fading coefficient and minimize the impact of incomplete CSI.

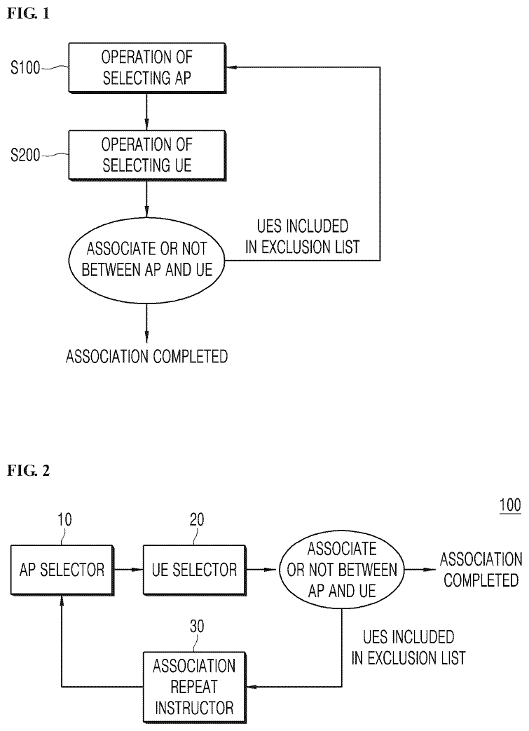

Based on the above, as shown in FIG. 1, a method for association between an AP and a UE for a massive access scenario using a low-resolution ADC in a user-centric cell-free massive MIMO system of the present disclosure will be described in detail.

### 1.1. Operation of Selecting AP (S100)

In an operation of selecting an AP (S100), each of two or more UEs may select a master AP among two or more APs according to a large-scale fading coefficient and request an association.

To this end, first, by using a matrix S representing an association state between the AP and the UE, an association relationship between each AP and the UE may be defined using the following Equation 1.

$${ℳ}_{k} = \{ l : {S}_{kl} - 1 , l ∈ \{ 1 , … , L \} \} , \\ {𝒜}_{l} = \{ k : {S}_{kl} = 1 , k ∈ \{ 1 , … , K \} \} \qquad [ Equation 1 ]$$

Here, [symbol] ₖ represents a set of APs supporting a UE k, and [symbol] ₗ represents a set of UEs supported by the AP l. Sₖₗ=1 represents that the UE k is connected to the AP l, which means that the AP l supports the UE k. When Sₖₗ=0, this means that the UE k is not associated with the AP.

For example, when the k-th row of a matrix S is [0,1,0,1], the UE k is associated with the second and fourth APs, where [symbol] ₖ={2,4}. In addition, when the l-th column of the matrix S is [1,0,1,1], the AP l supports first, third, and fourth UEs, where [symbol] ₖ={1,3,4}.

In other words, the initial connection of the operation of selecting an AP (S100) is a process in which each UE selects a master AP based on a large-scale fading coefficient. In this case, the master AP is represented by lₘ, and the APs may express the UEs that have selected themselves as the master AP in the

$$\{ {𝒜}_{{l}_{m}}^{M} \}$$

matrix.

The operation of selecting an AP (S100) is an initial process in which UEs establish an association with an optimal AP within the network, and is an operation in which each UE selects the AP most advantageous to itself and performs an association request. In this way, it is possible to optimize the efficiency and performance of the network.

To this end, in the operation of selecting an AP (S100), each UE may calculate the large-scale fading coefficient values with the APs. The large-scale fading coefficient is a value in which signal propagation characteristics between the UE and the AP are reflected, and may vary depending on the distance and environment. The value is an important factor in determining the association quality between the UE and the AP.

Therefore, each UE may compare the calculated large-scale fading coefficient values and select the AP with the highest large-scale fading coefficient value with the UE itself as the master AP. When the UE requests the association from the AP, a maximum value of the large-scale fading coefficient may be calculated using the following Equation 2.

$$l = arg {max}_{j ∈ {𝒞}_{k}} {β}_{kj} \qquad [ Equation 2 ]$$

Here, l is an index representing the optimal AP, meaning the AP to which the UE k will ultimately request the association. j represents an AP belonging to an AP candidate list, and [symbol] ₖ represents a set of all APs with which the UE k is capable of being associated. βₖₗ far represents an LSFC value between the UE k and an AP j, and arg max is a function that returns the index when a specific function has a maximum value, and returns the index of the AP where the LSFC value is maximum.

For example, when it is assumed that there are three APs, [symbol] ₖ may be {1,2,3}. When the UE k calculates the LSFC values with APs 1, 2, and 3, if the values are βₖ₁=0.4, βₖ₂=0.6, and βₖ₃=0.5, respectively, then an AP 2, which has the maximum LSFC value, is selected and l=2.

As described above, the present disclosure assumes the massive access scenario with a very large number of UEs. For this reason, an AP may receive more association requests than the pilot length during the process of electing a master AP.

When more UEs than the pilot length request the association from one AP, the AP may not process all of the requests, which may result in some UEs not being associated or experiencing poor performance.

Therefore, in an operation of selecting a UE (S200) of the present disclosure to be described below, each AP may go through a process of comparing large-scale fading coefficients to associate the AP with the UE having a larger large-scale fading coefficient and excluding association of a UE having a low large-scale fading coefficient. In this case, the UEs excluded from connection may be prevented from reconnecting by including the UEs in an exclusion list of the AP, which is expressed as Ex.

### 1.2. Operation of Selecting UE (S200)

As described above, in the operation of selecting a UE (S200), a first master AP that receives the association request from each UE may compare the large-scale fading coefficients of each of the UEs, and select and associate the UE having the largest large-scale fading coefficient value among the UEs that has requested the association.

As described above, the first master AP, a second master AP, and a first UE and a second UE described in the present disclosure are not limited by the terms including ordinal numbers such as first and second, but are only used to describe the components. The terms are used to distinguish one component from another component.

As can be seen from Equation 2 described above, each UE selects an AP having the largest large-scale fading coefficient value with the UE itself as the master AP and requests the association.

In this case, when [symbol] ₗ is less than the pilot length, the AP l and the UE k are associated, the AP l is included in the set [symbol] ₖ of APs that support the UE k, and the UE k is included in the set [symbol] ₗ of UE supported by the AP l.

In the present disclosure, in the method in which an AP associates itself with the UE having the largest large-scale fading coefficient value, and when the number of currently supporting [symbol] ₗ exceeds 1, the AP may release the association with or exclude some of UEs that the AP supports.

On the other hand, when [symbol] ₗ is longer than the pilot length, the AP l will compare the large-scale fading coefficient values of the UEs that the AP supports and UEs whose association requests the AP has newly received. In this case, the association of the UE having the smallest large-scale fading coefficient value is excluded, and this may be expressed by Equation 3.

$${k}^{′} = arg {max}_{i ∈ {𝒜}_{l} \backslash {𝒜}_{l}^{M}} {β}_{ii} \qquad [ Equation 3 ]$$

Here, k′ represents the index of a UE with which the association is released, i represents the index of the UEs currently supported by the AP l,

$${𝒜}_{l} \backslash {𝒜}_{l}^{M}$$

represents a set of remaining UEs after excluding a set

$${𝒜}_{l}^{M}$$

of UEs included in the exclusion list from a set [symbol] ₗ of UEs supported by the AP, and βᵢₗ represents an LSFC value between the UE i and the AP l.

For example, when the AP l currently supports four UEs (1, 2, 3, 4) and the pilot length is 3, the AP/may only support at most three UEs. Here, it is assumed that βᵢ₁=0.8, βᵢ₂=0.6, βᵢ₃=0.4, βᵢ₄=0.5, and there is not wie sel

$${𝒜}_{l}^{M}$$

of UEs included in the exclusion list.

The AP l finds the UE having the lowest LSFC value among the UEs that are being currently supported. Since [symbol] ₗ={1, 2, 3, 4} and there is not

$${𝒜}_{l}^{M} , {𝒜}_{l} \backslash {𝒜}_{l}^{M} = {𝒜}_{l} ,$$

and since βᵢ₃=0.4 is the minimum value, k′=3.

Therefore, the AP l may release the association with or exclude the UE 3 and include the UE 3 in the exclusion list, and thus the set of UEs supported may be AP l={1,2, 4}.

That is, among the APs, the master AP (which may be referred to as the first master AP) that has received the association request from each of the UEs compares the large-scale fading coefficients with each of the UEs, and selects and associates the UE (which may be referred to as the first UE) having the largest large-scale fading coefficient value among the UEs that have requested the association. In this case, the first master AP excludes may exclude association requests from other UEs having lower large-scale fading coefficients than the first UE as the result of the comparison.

The excluded UEs may be included in the exclusion list of the first master AP to prevent re-association.

### 1.3. Operation of Repeating Association (Not Shown)

FIG. 3 shows a pseudocode representing an association algorithm between an AP and a UE proposed in the present disclosure.

The algorithm aims to maximize spectral efficiency in a cell-free massive MIMO system by optimizing the association between the UE and the AP. Each operation continuously updates an association state and may guarantee the optimal association based on the fading coefficient between the UE and the AP.

In the operation of repeating the association, as described above, when the number of UEs supported by the AP l exceeds the pilot length, the AP l may release the association with or exclude some of the UEs supported by the AP l itself, and this process is an operation that is repeatedly performed until all UEs [symbol] ₖ are associated.

In other words, the UEs included in the exclusion list may perform the operation of selecting an AP (S100) again, and the master AP (which may be referred to as the second master AP) that has received the association request in the re-performed operation of selecting an AP (S100) may perform the operation of performing a UE (S200) again.

That is, the operation of repeating the association is an operation of repeatedly performing the operation of selecting an AP (S100) and the operation of selecting a UE (S200) until all UEs within the network establishes an optimal association with the AP. In this way, it is possible to optimize network performance and guarantee association stability for UEs.

As described above, the method for association between an AP and a UE for the massive access scenario using the low-resolution ADC in the user-centric cell-free massive MIMO system according to the present disclosure is a method in which each UE calculates large-scale fading coefficients with all APs within the network, selects an AP having the largest large-scale fading coefficient value, and transmits the association request.

In addition, the AP that has received the association request may check whether the number of UEs that are currently being supported exceeds the pilot length, the AP may accept the association request when the number does not exceed the pilot length, the AP may release the association with or exclude some UEs when the number exceeds the pilot length.

Since the AP selects the UE having the largest LSFC in the AP association request, association requests of other UEs besides the selected UE may be rejected.

For the other UEs, the AP may release or exclude the UE having the smallest large-scale fading coefficient value and include the UE in the exclusion list to prevent re-association.

The UE whose association has been released performs the operation of selecting an AP (S100) again to attempt to be associated with another AP, and the process is repeated until all UEs are associated with an AP.

In other words, the operation of selecting an AP (S100) and the operation of selecting a UE (S200) may be repeated until all UEs within the network are associated with an appropriate AP.

In the user-centric cell-free massive MIMO system utilizing the method for association between the AP and the UE according to the present disclosure as described above, a system for association between an AP and a UE for a massive access scenario using a low-resolution ADC will be described in detail as follows.

### 2. System (100) for Association Between AP and UE

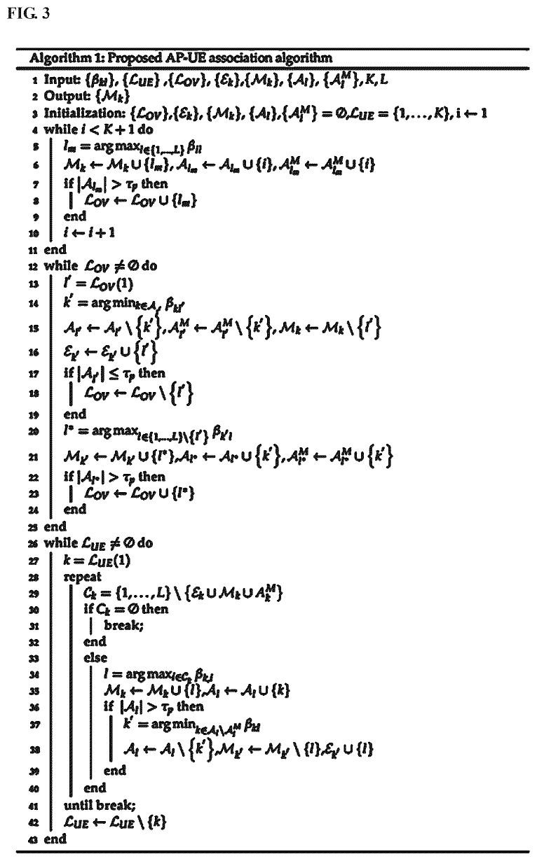

The present disclosure provides a system 100 for association between an AP and a UE for a massive access scenario using a low-resolution analog to digital converter (ADC) in a user-centric cell-free massive MIMO system, and as shown in FIG. 2, the system 100 for association between an AP and a UE includes an AP selector 10 that performs a process in which K UEs selects a master AP among L APs according to a large-scale fading coefficient to request an association, a UE selector 20 that performs a process in which the master AP that has received the association request from the K UEs selects a UE to be associated according to the large-scale fading coefficient, and an association repeat instructor 30 that instructs UEs that are not associated through the processes of the AP selector 10 and the UE selector 20 to repeat the processes of the AP selector 10 and the UE selector 20 until all of the UEs are associated with an AP.

### 2.1 AP Selector (10)

The AP selector 10 may perform a process in which each of the two or more UEs calculates large-scale fading coefficient values with the APs, and each UE selects the AP having the largest large-scale fading coefficient value as a master AP to request an association.

In other words, the AP selector 10 may perform an initial process in which the UE selects an optimal AP within the network and establishes the association, and to this end, a CPU (not shown) may calculate large-scale fading coefficients between each UE and the APs, and support the UE to select the optimal AP based on the calculation result.

When the AP receives the association request from the UE, the CPU may support efficient processing of the request. To this end, the CPU may check the AP's pilot length and make a decision to accept or reject the association request.

### 2.2. UE Selector (20)

The UE selector 20 may perform a process in which the AP that has received an association request from the UEs selects a UE to be associated according to the large-scale fading coefficient to perform the association.

Among the APs, the master AP (which may be referred to as the first master AP) that has received the association request from each of the UEs compares the large-scale fading coefficients with each of the UEs, and selects and associates the UE (which may be referred to as the first UE) having the largest large-scale fading coefficient value among the UEs that have requested the association. The first master AP may exclude association requests from other UEs having lower large-scale fading coefficients than the first UE as a result of the comparison.

In addition, the first master AP may prevent re-association by including UEs whose association requests are excluded in its exclusion list.

To this end, the CPU may compare large-scale fading coefficients of UEs from which the AP has received the association requests so that an optimal UE may be selected. In addition, the CPU may monitor the AP's pilot length to maintain the association within the maximum pilot length.

The CPU may make an adjustment so that the AP releases the association with or exclude UEs having low large-scale fading coefficients when the AP's pilot length is exceeded and associates the AP itself with a new UE.

In addition, the CPU may separately configure an exclusion list portion (not shown) to manage the exclusion list so that association-released or excluded UEs do not attempt to re-associate.

### 2.3. Association Repeat Instructor (30)

The association repeat instructor 30 may instruct the AP selector 10 and the UE selector 20 to repeat the processes of the AP selector 10 and the UE selector 20 until all UEs that have not been associated through the processes are associated with at least one AP.

That is, the association repeat instructor 30 may instruct the UEs included in the previously described exclusion list to perform the process of the AP selector 10 again, and another master AP (which may be referred to as the second master AP) that has received the association request in the process to perform the process of the UE selector 20 again.

The process may perform the process of the AP selector 10 until all of the K UEs are associated, and a predetermined master AP that has received the association request during the process of the AP selector 10 may instruct the UE selector 20 to perform its process until all of the K UEs are associated.

To this end, the CPU may instruct that the AP selection and UE selection processes be repeatedly performed until all UEs within the network are associated with an AP, and during the process, the exclusion list may be updated in the exclusion list portion to ensure efficient association.

In addition, the CPU may separately configure an association completion list portion (not shown) to manage an association completion list of UEs and APs associated through the processes of the AP selector 10 and the UE selector 20.

As described above, in the system 100 for association between the AP and the UE for the massive access scenario using the low-resolution ADC in the user-centric cell-free massive MIMO system according to the present disclosure, the AP selector 10 may guarantee efficient distribution of network resources by allowing each UE to be associated with an optimal AP by the UE selecting the AP.

The UE selector 20 may prevent resource waste by allowing the AP to select an optimal UE and release unnecessary associations, and may maximize resource efficiency by repeating the process until all UEs within the network are associated with an appropriate AP through the association repeat instructor 30.

Therefore, the method for association between the AP and the UE of the present disclosure and the system using the same may obtain effects of efficient resource management, high spectral efficiency performance, stable connectivity, network expandability and flexibility, and power consumption and cost reduction in the massive access scenario using the low-resolution ADC in the user-centric cell-free massive MIMO system.

### 3. Example-Simulation Comparison Result

As previously described, the present disclosure has assumed that a low-resolution ADC is used to reduce fronthaul capacity.

The low-resolution ADC consumes less power than the high-resolution ADC, which is especially important in the massive MIMO system that supports a large number of UEs using a large number of antennas. In addition, the low-resolution ADC may reduce the hardware cost of the entire system compared to the high-resolution ADC, thereby lowering the system construction cost.

The low-resolution ADC has a fast data processing speed since the amount of converted data is small, which is important in communication systems that require data processing in real time. In addition, data storage space may be saved since the number of bits in the converted data is small.

The low-resolution ADC is relatively simple to design and implement, and may reduce the complexity of the system, thereby increasing the stability and reliability of the system.

Using the low-resolution ADC may reduce the amount of converted data, which may also reduce the fronthaul capacity requirements of the network. This may be a significant advantage in the massive MIMO system where a large number of APs are transmitting and receiving data to and from the CPU.

Therefore, in the present disclosure, the spectral efficiency (SE) performance may be improved by reducing the fronthaul link load using a low-resolution ADC, and this can be expressed by the following Equation 4.

$${SE}_{k} = ( 1 - \frac{{τ}_{p}}{\text{?}} ) {log}_{2} ( 1 + {SINR}_{k} ) \qquad [ Equation 4 ]$$

$$\text{?} \text{indicates text missing or illegible when filed}$$

Here, SE, is a spectral efficiency of a user k, τₚ is a pilot signal length, and τ_{c} is the length of a coherence block, which is a time-frequency block in which the channel state remains constant. Equation 4 may handle a scenario using the low-resolution ADC in the cell-free massive MIMO system. In addition, Equation 4 may be used to analyze the spectral efficiency in the massive access environment.

A signal-to-interference-plus-noise ratio (SINR) of Equation 4 may be expressed by Equation 5 below.

$${SINR}_{k} = \frac{{α}^{2} {ρ}_{k} \vert {w}_{k}^{H} {f}_{k} \vert}{\begin{matrix}{w}_{k}^{H} ( {α}^{2} {\sum }_{j = 1}^{K} {ρ}_{j} {Λ}_{kl}^{( 1 )} - \\ {α}^{2} {ρ}_{k} {f}_{k} {f}_{k}^{H} + {α}^{2} {σ}^{2} {Λ}_{k}^{( 2 )} + {Λ}_{k}^{( 3 )} ) {w}_{k}\end{matrix}} \\ {w}_{k} = {[ {w}_{k 1} , … , {w}_{kL} ]}^{T} \qquad [ Equation 5 ]$$

$${f}_{k} = {[ 𝔼 \{ {v}_{k 1}^{H} {D}_{k 1} {g}_{k 1} \} , … , 𝔼 \{ {v}_{kL}^{H} {D}_{kL} {g}_{kL} \} ]}^{T}$$

$${Λ}_{kl}^{( 1 )} = [ 𝔼 \{ {v}_{kl}^{H} {D}_{kl} {g}_{jl} {g}_{jm}^{H} {D}_{km} {v}_{km} \} : l , m = 1 , … , L ]$$

$${Λ}_{k}^{( 2 )} = diag ( 𝔼 \{ {‖ {D}_{kl} {v}_{k 1} ‖}^{2} \} , … , 𝔼 \{ {‖ {D}_{kL} {v}_{kL} ‖}^{2} \} )$$

$${Λ}_{k}^{( 3 )} = [ 𝔼 ( {v}_{kl}^{H} {D}_{kl} {\overline{n}}_{jl} {\overline{n}}_{jm}^{H} {D}_{km} {v}_{km} \} : l , m = 1 , … , L ]$$

Here, SINRₖ represents a signal-to-interference-plus-noise ratio of a user k, α represents a system parameter, ρₖ represents a transmit power of the user k, wₖ represents a receive filter vector of the user k,

$${w}_{K}^{H}$$

represents a conjugate transpose of the receive filter vector of the user k, fₖ represents a channel vector of the user k, σ² represents a noise variance,

$${Λ}_{kl}^{( 1 )}$$

represents a multi-user interference matrix, indicating interference between a user j and k at the APs l and m,

$${Λ}_{k}^{( 2 )}$$

represents a matrix whose diagonal elements are expected power values of multipath channels, and

$${Λ}_{k}^{( 3 )}$$

represents a noise term of the user k.

Through Equation 6, the strength of a signal of the specific user k may be measured by comparison with interference from other users and noise within the system, and through the measurement, the signal quality and performance of the system may be evaluated.

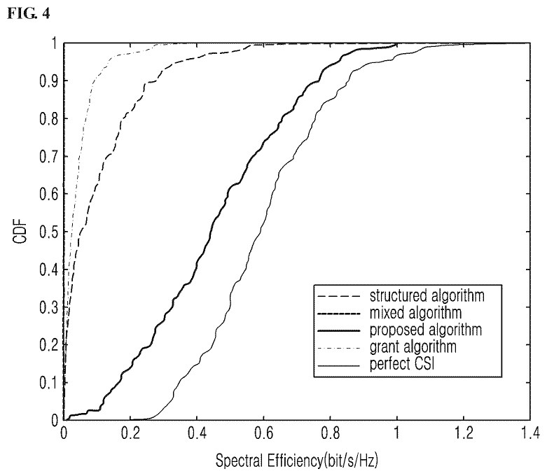

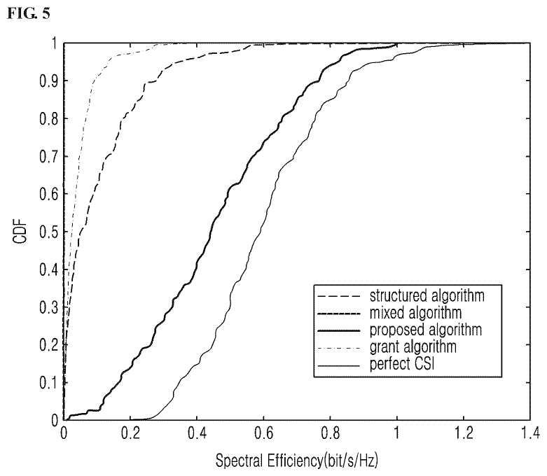

FIGS. 4 to 7 are graphs showing simulation results comparing the algorithm proposed in the present disclosure with other algorithms.

In the present disclosure, it is assumed that APs and users are randomly distributed within a range of 0.5×0.5 km. It is assumed that there are L of APs, where L=50, each AP has N antennas, where N=4, and K users with one antenna are distributed, where K=100, 160. In addition, it is assumed that for a transmission coherence block. τ_{c}=200, for the pilot, τₚ=10, and all users have the same ρₖ=100 mW.

In the present disclosure, a simulation was conducted using a maximum ratio (MR) combiner and a local partial-minimum mean square error (LP-MMSE) combiner, which are combiners mainly used in the cell-free massive MIMO system, and through FIGS. 4 to 7, it can be confirmed that the spectral efficiency performance has increased compared to an existing clustering method.

The MR combiner is a simple and efficient way to combine received signals at an optimal ratio to maximize a signal-to-noise ratio (SNR). The MR combiner has an advantage of being very simple to calculate and easy to implement since each received signal is combined in the same ratio.

The LP-MMSE combiner is a way to combine received signals while minimizing noise and interference when processing the signals, and is an approach that optimizes the performance of each local area rather than the performance of the entire network.

The LP-MMSE combiner is more computationally complex than the MR combiner, and has to consider various parameters to minimize noise and interference of each signal. The LP-MMSE combiner is mainly used in the cell-free massive MIMO system and may be advantageous in minimizing interference between multiple users and multiple APs.

FIG. 4 is a graph showing the spectral efficiency performance using the MR combiner when K=100.

An X-axis represents the amount of data capable of being transmitted per unit frequency bandwidth, which means spectral efficiency performance. A Y-axis represents a cumulative distribution function (CDF), which is a function that represents a probability of being below a specific value. The purpose of using the CDF in the spectral efficiency graph is to visually represent the probability of occurrence below a certain spectral efficiency value.

For example, when a CDF value is 0.7 when the certain spectral efficiency value is 0.4, this may mean that 70% of the total samples are below the corresponding spectral efficiency value. In other words, it indicates that 70% of users are experiencing a spectral efficiency of 0.4 bit/s/Hz or less.

Therefore, a further skew of the graph to the upper left, that is, the CDF closer to 1 at low spectral efficiency values means worse performance of the algorithm.

Therefore, a further skew of the graph to the lower right, that is, the CDF closer to 1 at high spectral efficiency values means better performance of the algorithm.

Looking at the graph in FIG. 4 based on the above description, it can be seen that the proposed algorithm of the present disclosure is overall more skewed to the right. This means that at a certain spectral efficiency value, the proposed algorithm has a higher spectral efficiency value. However, here, perfect CSI means an ideal state with perfect channel state information conditions.

FIG. 5 is a graph showing the spectral efficiency performance using the MR combiner when K=160, and it can be confirmed that the spectral efficiency performance of the proposed algorithm is much superior compared to FIG. 4.

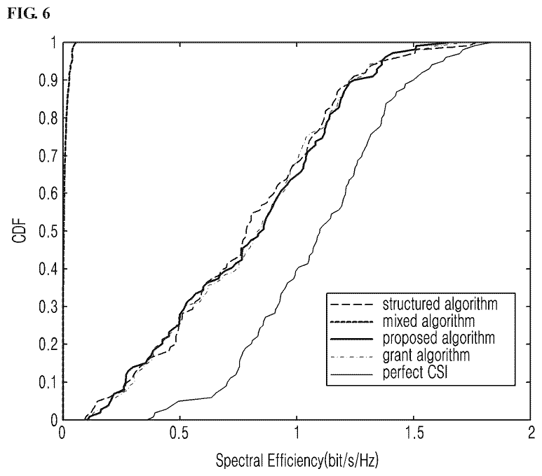

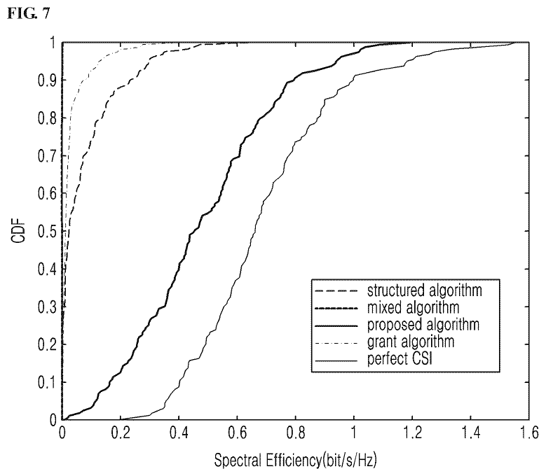

FIG. 6 and FIG. 7 are graphs showing the spectral efficiency performances using the LP-MMSE combiner, respectively, when K=100 and when K=160.

As shown in the graph in FIG. 6, it can be seen that the proposed algorithm of the present disclosure is overall more skewed to the right. This means that at a certain spectral efficiency value, the proposed algorithm has a higher spectral efficiency value.

The graph in FIG. 7 clearly shows that the spectral efficiency performance of the proposed algorithm is much superior compared to FIG. 6.

As described above, it can be seen that the spectral efficiency performance is improved compared to the existing clustering method, through the proposed association algorithm between the AP and the UE of the present disclosure.

According to the present disclosure, it is possible to guarantee the association between APs and all UEs within a network can be guaranteed, possible to guarantee the performance of all UEs by preferentially selecting an AP capable of providing an excellent large-scale Fading coefficient (LSFC), and possible to reduce performance degradation of each AP due to pilot interference by avoiding an overserving AP that selects more UEs than a pilot length.

Meanwhile, although the technical spirit of the present disclosure as described above has been specifically described according to the above embodiments, it should be noted that the above embodiments are for explanation and not for limitation. In addition, those skilled in the art will understand that various embodiments are possible within the scope of the technical spirit of the present disclosure.

(Reference Signs List)

| | |
|---|---|
| 10: AP selector | 20: UE selector |
| 30: Association repeat instructor | 100: System for association |
| | between AP and UE |
| S100: Operation of selecting AP | S200: Operation of selecting UE |

What is claimed is:

1. A method for association between an AP and a user equipment (UE) for a massive access scenario using a low-resolution analog to digital converter (ADC) in a user-centric cell-free massive MIMO system, the method comprising:
selecting, by each of two or more UEs, an AP as a master AP among two or more APs according to a large-scale fading coefficient (LSFC) to request an association;
selecting, by the master AP that has received the association request from the two or more UEs, a UE to be associated according to the large-scale fading coefficient to perform the association; and
repeating the association by re-performing, by UEs that are not associated through the selecting of the AP and the selecting of the UE, the selecting of the AP and the selecting of the UE.

2. The method of claim 1, wherein in the selecting of the AP,
each of the UEs calculates large-scale fading coefficient values with the APs, and
each of the UEs selects the AP having a largest large-scale fading coefficient value with the UE itself as the master AP and requests the association.

3. The method of claim 1, wherein in the selecting of the UE,
a first master AP that has received the association request from each of the UEs among the APs compares the large-scale fading coefficients with each of the UEs,
a first UE having a maximum value among the large-scale fading coefficient values of the UEs requesting the association is selected and associated, and
the first master AP excludes association requests from UEs having lower large-scale fading coefficients than the first UE as a result of the comparison.

4. The method of claim 3, wherein the first master AP prevents re-association by including the excluded UEs in an exclusion list of the first master AP.

5. The method of claim 4, wherein in the repeating of the association,
the UEs included in the exclusion list performs the selecting of the AP again, and
a second master AP that has received the association request in the selecting of the AP performed again performs the selecting of the UE again.

6. The method of claim 1, wherein in the repeating of the association, the selecting of the AP and the selecting of the UE are repeated until all of the UEs are associated with at least one AP.

7. A system for association between an AP and a UE for a massive access scenario using a low-resolution analog to digital converter (ADC) in a user-centric cell-free massive MIMO system, the system comprising:
an AP selector configured to perform a process in which each of two or more UEs selects a master AP among two or more APs according to a large-scale fading coefficient to request an association;
a UE selector configured to perform a process in which the master AP that has received association requests from the two or more UEs selects a UE to be associated according to the large-scale fading coefficient to perform the association; and
an association repeat instructor configured to instruct UEs that are not associated through the processes of the AP selector and the UE selector to re-perform the processes of the AP selector and the UE selector.

8. The system of claim 7, wherein the AP selector is configured such that
each of the UEs calculates large-scale fading coefficient values with the APs, and
each of the UEs selects the AP having a largest large-scale fading coefficient value with the UE itself as the master AP and makes the association request.

9. The system of claim 7, wherein the UE selector is configured such that
a first master AP that has received the association request from each of the UEs among the APs compares the large-scale fading coefficients with each of the UEs,
a first UE having a maximum value among the large-scale fading coefficient values of the UEs requesting the association is selected and associated, and
the first master AP excludes association requests from UEs having lower large-scale fading coefficients than the first UE as a result of the comparison.

10. The system of claim 9, wherein the first master AP prevents re-association by including the UEs whose association requests are excluded in an exclusion list of the first master AP.

11. The system of claim 10, wherein the association repeat instructor is configured to instruct:
the UEs included in the exclusion list to perform the process of the AP selector again, and
a second master AP that has received the association request from the AP selector that has performed the process again to perform the process of the UE selector again.

12. The system of claim 7, wherein the association repeat instructor is configured to \repeatedly perform the processes of the AP selector and the UE selector until all of the UEs are associated with at least one AP.
